(19) United States
(12) Patent Application Publication
(10) Pub. No.: US 2012/0021123 A1
(43) Pub. Date: Jan. 26, 2012

(54) PROCESS TO SEQUESTER CARBON, MERCURY, AND OTHER CHEMICALS

(76) Inventors: Philip D. Leveson, Sandy Springs, GA (US); John P. Gaus, Watertown, NY (US)

(21) Appl. No.: 13/009,484

(22) Filed: Jan. 19, 2011

Related U.S. Application Data
(60) Provisional application No. 61/296,149, filed on Jan. 19, 2010.
(60) Provisional application No. 61/326,208, filed on Apr. 20, 2010.

(51) Int. Cl. C01B 31/08; C02F 1/28; F23G 5/00; C10J 3/46; B05C 1/04; A01B 79/00; B01D 53/02; B09B 5/00; C02F 101/20; C02F 103/06; C02F 101/30

(52) U.S. Cl. 427/136; 95/90; 210/660; 110/255; 48/197 R; 405/129.95; 172/1

(57) ABSTRACT

Biomass is devolatilized to produce both a combustible fuel (syngas) and activated carbon. The activated carbon is used as an adsorbent to capture a contaminant, such as mercury, and stored in a landfill, is impregnated with components with inherent fertilizer properties and tilled into arable land, is used along with coal in an electric power generation facility, or is used to remove mercury or other heavy metals from the flue gas of a coal fired power generation station prior to being stored so as to sequester both carbon and the heavy metal. Thus, both the carbon and the adsorbed mercury or other chemical are sequestered.

### PRIORITY CLAIM

This application claims the priority of U.S. Provisional Patent Application Ser. No. 61/296,149, filed Jan. 19, 2010, entitled “A Process To Sequester Carbon”.

### FIELD OF THE INVENTION

The present invention relates to a process to sequester carbon and to use the carbon to also sequester mercury, other heavy metals, and/or other contaminants.

### BACKGROUND OF THE INVENTION

It is increasingly accepted that increased carbon dioxide production results in increased concentrations of that gas in the atmosphere and is having a dramatic effect on the climate of the planet. Utilizing biomass as a fuel to directly offset fossil fuels is gaining popularity as this reduces the rate of carbon dioxide production and the need to find further fossil fuels. There is still a net carbon dioxide gain, however, because little, if any, of the carbon in the biomass is removed and most of the carbon will still end up in the atmosphere as carbon dioxide.

### SUMMARY OF THE INVENTION

Carbon is sequestered by devolatizing a carbon-containing feedstock, preferably at a high temperature, to produce activated carbon which is preferably then used in a manner other than burning. The activated carbon may be impregnated with certain additives and used with land to improve the crop-growing characteristics of the land, or may be used with or without additives to improve the texture and water-retention properties of the land. The activated carbon may also be used to adsorb contaminants. When the adsorption capability of the activated carbon which has been used to adsorb contaminants becomes diminished, the used activated carbon is preferably placed in a secure landfill, that is, a landfill constructed so that the contaminants are not quickly released back into the environment.

### DETAILED DESCRIPTION OF THE INVENTION

A combustible fuel, such as syngas, and activated carbon are produced from biomass. The activated carbon may be placed directly on or in the earth, for example, as a carrier of nutrients to enhance the fertility of the earth. The activated carbon may also be used in another process, such as an adsorbent, and then, after use, is disposed of, such as by being placed in a secure landfill where the contaminant will not be quickly released into the environment. The activated carbon may also be utilized as an absorbent or adsorbent material to capture mercury or other heavy metal, such as from the flue gas of a coal-fired power station, prior to being stored in the earth or in a secure landfill as a means to sequester both carbon and mercury.

Through devolatization, biomass can be separated into a gaseous fuel (syngas) and fixed carbon. The gaseous fuel can be combusted directly to offset fossil fuel use, and the fixed carbon can be safely stored in the earth as a means of sequestering the carbon. The amount of carbon dioxide generated by a process is often referred to as the “carbon footprint” of that process. Thus, if enough of the carbon in the biomass is sequestered, the overall carbon footprint of the process may become negative. Also, using the syngas to offset fossil fuel use may reduce carbon dioxide emissions as compared to the carbon dioxide emissions from the use of just fossil fuel. The use of syngas also allows for other uses of the fossil fuels, such as use in the manufacture of plastics and chemicals.

If a high temperature process is used for devolatilization of the biomass, a highly activated carbon (activated charcoal) can be produced. The activated carbon can be used as an adsorbent to capture a pollutant and then stored in a land fill, or can be impregnated with components with inherent fertilizer properties and then spread on or tilled into land, preferably but not necessarily arable land.

The activated carbon component may also be utilized to capture mercury or other heavy metal from the stack or flue gas of a coal-fired power station prior to being stored in the earth as a means of sequestering both the carbon and the heavy metal.

The sequestration of carbon enhances the quality of the environment and reduces greenhouse gas emissions by using and/or sequestering the carbon in materials that might otherwise be tossed into a landfill or even simply burned. The quality of the environment is also enhanced by the sequestration of carbon which has been used to capture contaminants by removing the carbon, mercury, or other contaminant.

In a preferred embodiment a high temperature gasification process is used to devolatilize the biomass. In the gasification process a small and substoiciometric amount of air is available for interaction with the biomass. This controlled, oxygen-starved environment results in syngas being produced with significant concentrations of carbon monoxide and hydrogen. This gaseous mixture can be combusted directly or used as starting point for the synthesis of a wide number of chemicals and fuels including gasoline, diesel-methanol fuel, and ammonia. Conducting the gasification process at high temperature also results in the production of a carbon with a very high surface area, often referred to as activated carbon, activated charcoal, or char.

This high temperature gasification process can be conducted in a number of different gasification apparatus, including but not limited to updraft, downdraft, sidedraft or fluidized bed systems, but a downdraft gasifier is preferred. A suitable downdraft gasifier system is disclosed in U.S. Pat. No. 7,569,204. Depending on how the gasifier is operated, up to 30% of the mass of the biomass feed is converted to char. If an updraft or downdraft gasifier is used and the amount of air and the grate preferably can be controlled and/or modified to allow controllable passage of the char through the grate for collection, thus enabling char production to be maximized. Preferably, the grate structure can be activated as necessary to produce an even material flow across the entire cross section of the gasification device. Examples of such grate designs include rotating grates, sliding grates, variable aperture grates, vibrating grates and dumping grates. Preferably, the gasifier has a bed temperature in the range of 500 to 1200 ° C., and the residence time of the feedstock in the bed is at least two minutes.

A number of feedstocks are suitable feeds for this gasification process, including biomass, agricultural wastes, refuse derived components and, indeed, almost any carbon-containing feedstock which can be combusted in an exothermic manner and, preferably, which can be pelletized. If the fuel is pelletized prior to gasification then an activated charcoal pellet can be produced with similar dimensions to the feedstock pellets, and with enhanced mechanical strength as compared to the solid produced from non-pelletized feedstocks.

The activated carbon may undergo further activation through thermal and or steam treatments to adjust surface area, inter-particle and intra-particle void size, and pore size distributions of the internal porous matrix. The skeletal structure of the activated carbon may also undergo impregnation of compounds to increase its ability to capture mercury or other heavy metal. Such treatments may include, for example, the impregnation of sulphur, the acid derivatives of sulphur oxides, or ionic halogen salts (e.g., potassium iodide). Impregnation may be undertaken by standard methods including incipient wetness or vapor deposition techniques.

The pelletized activated carbon can also be readily packed to produce fixed beds which can then be used to capture components from both gaseous and liquid streams. For example, the activated carbon can be used as an adsorbent to capture VOCs (volatile organic compounds) or other contaminants.

The activated carbon can therefore be used in a number of ways prior to being returned to the earth. A number of examples are given below. The list below is non exhaustive and is provided purely to demonstrate the potential synergies and applications of the current process. The syngas may be used, but is not necessarily used, as mentioned herein.

Some particular examples of the manufacture and use of the carbon pellets are below.

Example 1. A downdraft gasifier, with a grate as described above, is used to convert wood pellets into syngas and activated charcoal pellets. The pellets are used at a landfill site to scrub siloxanes or other contaminants from landfill gas prior to the scrubbed landfill gas being combusted, such as in an internal combustion engine or a boiler. Once the pellets become saturated, or so nearly saturated as to reduce their efficiency in scrubbing, the spent activated charcoal pellets are added back to the landfill, or stored in a different landfill designated especially for such contaminants so as to remove the possibility of leakage or leaching which could reintroduce the adsorbed contaminants back into the same landfill. This provides for both use and sequestration of the carbon, and for sequestration of the contaminant.

Example 2. A downdraft gasifier is used to convert wood chips into syngas and activated charcoal. The charcoal may be impregnated with components containing nitrogen, phosphorus, potassium, ionic salts, organic carbon compounds, fertilization additives, and/or trace minerals. The treated carbon solid is tilled into or spread on agricultural land, preferably but not necessarily arable land, residential land, or even open space land, to improve fertility, minimize fertilizer runoff, improve water retention, and modify the soil texture and/or other characteristics of the land. The type and degree of impregnation may be varied in accordance with the conditions of the land where it is to be applied so as to avoid creating undesirable imbalances of minerals in the soil. The charcoal may also be directly applied to the land with or without additives to minimize fertilizer runoff, improve water retention, and modify the soil texture.

Example 3. A downdraft gasifier is used to convert wood pellets into syngas and activated charcoal pellets. The pellets are used at a landfill site to remove organic components, , heavy metals and/or other contaminants from a leachate stream. Once the pellets have become saturated, or so nearly saturated as to reduce their efficiency in removal of contaminates from the leachate stream, the spent activated charcoal pellets are added to the same landfill or a different landfill designated especially for such contaminants so as to remove the possibility of leakage or leaching which could reintroduce the adsorbed contaminants back into the same landfill. This provides for both use and sequestration of the carbon, and for sequestration of the contaminant.

Example 4. An updraft gasifier, with a grate as described above, is used to convert wood pellets into syngas and activated charcoal pellets. The pellets are used at the gasification site to remove any organic fractions or heavy metals from any wet scrubbing system, such as may be used in the preparation of the wood pellets. Once the pellets have become saturated, or so nearly saturated as to reduce their efficiency in removal or scrubbing, the spent activated charcoal pellets are added to a secure landfill for carbon and contaminant sequestration, thereby both using and sequestering the carbon and capturing and sequestering the contaminant.

Example 5. A downdraft gasifier, with a grate as described above, is used to convert pellets made from empty fruit basket pellets into syngas and activated charcoal pellets. The activated charcoal pellets are transported to a coal-fired electrical generation plant and co-fired with coal as a means of increasing the extent to which biomass derived fuels can be directly combusted in existing coal facilities. This reduces the amount of material being deposited in the landfill and reduces the amount of coal that must be mined, transported, and pulverized. The mining, transporting, and pulverizing operations all cause the generation of carbon dioxide, directly or indirectly, so reducing these activities reduces the amount of carbon dioxide that is generated.

Example 6. A downdraft gasifier, with a grate as described above, converts wood pellets into a gaseous fuel (syngas) and activated charcoal pellets. The pellets are used within a packed bed to remove mercury from the stack gas of a coal-fired power station. Once spent the carbon is sequestered in a secure landfill site or may be used for another purpose where the mercury or heavy metal is not thereafter released into the environment.

Example 7. A downdraft gasifier converts wood chips into a gaseous fuel (syngas) and activated charcoal. The charcoal may be impregnated with components to enhance mercury capture characteristics. The impregnated activated carbon is ground to a selected characteristic length or size and injected directly into the flue from a coal-fired power station (sometimes known as duct injection). The finely divided carbon is recovered in a baghouse or electrostatic precipitator and placed in a secure landfill, or may be used for another purpose where the mercury or heavy metal is not thereafter released into the environment.

Example 8. An updraft gasifier, with a grate as described above, converts empty fruit basket pellets into a gaseous fuel (syngas) and activated charcoal pellets. The pellets are transported to an integrated gasification combined cycle (IGCC) coal-fired electrical power generation plant. The pellets are used to adsorb mercury from the syngas stream prior to combustion of the gaseous fuel in the power generation plant. Once spent the adsorbent material is placed in a secure landfill, or may be used for another purpose where the mercury or heavy metal is not thereafter released into the environment.

Thus, biomass feedstock is devolatilized through a gasification process to produce a combustible gas and activated carbon. A fraction of the activated charcoal may be removed from the gasification system and the activated carbon may be used to capture mercury, heavy metals, and/or other contaminants from the flue gas of a coal-fired power station. The carbon and captured material are sequestered by storing the carbon in a secure landfill or by using it for another purpose where the carbon and captured material are not thereafter released into the environment.

Sequestering the produced activated charcoal thus directly reduces the carbon footprint, and replacing another fuel with the produced charcoal and/or syngas reduces the carbon footprint by eliminating the processing requirements for such other fuel.

The carbon is preferably, but not necessarily, further activated through thermal and or steam treatments to adjust the surface area, inter-particle and intra-particle void fraction, and pore size distribution prior using it capture mercury or other contaminant. Also, preferably, but not necessarily, the activated carbon is impregnated with a component to modify the mercury or contaminant capture behavior of the char. For example, the char may be impregnated with sulphur to enhance the ability of the char to capture mercury, or with potassium bromide to more strongly bind the mercury.

Also, the activated charcoal may be used, such as by impregnating it with additives for use a soil condition and/or fertilizer, using it to improve the water retention properties or texture of land, using it to scrub siloxanes from landfill gas prior to being stored in a landfill or the same landfill, using it to remove organic components and heavy metals from a leachate stream prior to being stored in a landfill or the same landfill, using it to remove organic fractions or heavy metals from a wet scrubbing system prior to being stored in a landfill or the same landfill, co-firing it with coal at coal-fired electrical generation plant.

Although various embodiments of the present invention have been described in detail herein, other variations may occur to those reading this disclosure without departing from the spirit of the present invention. Accordingly, the scope of the present invention is to be limited only by the claims.

1. A process to sequester carbon, comprising:
devolatizing a carbon-containing feedstock to produce free carbon; and
disposing of said free carbon in a manner other than burning it.

2. The process of claim 1 wherein said devolatizing produces activated carbon.

3. The process of claim 1 and further comprising pelletizing said carbon-containing feedstock before said devolatizing.

4. The process of claim 1 wherein said devolatizing also produces syngas.

5. The process of claim 1 wherein said disposing of said free carbon comprises spreading said free carbon on land.

6. The process of claim 1 wherein said disposing of said free carbon comprises burying said free carbon.

7. The process of claim 1 wherein said devolatizing produces activated carbon and said disposing of said free carbon comprises using said activated carbon as an adsorbent to remove at least some contaminants from at least one of a gaseous stream or a liquid stream.

8. The process of claim 7 wherein said at least one of a gaseous stream or a liquid stream emanates from a landfill.

9. The process of claim 1 wherein said devolatizing produces activated carbon;
and further comprising impregnating said activated carbon with a component containing at least one of organic carbon compounds, ionic salts, fertilization additives, nitrogen, phosphorous, potassium, or trace minerals; and
said disposing of said free carbon comprises at least one of spreading said impregnated activated carbon onto land or tilling said impregnated activated carbon into land.

10. The process of claim 1 wherein said devolatizing produces activated carbon;
and further comprising impregnating said activated carbon with a component containing at least one of organic carbon compounds, ionic salts, fertilization additives, nitrogen, phosphorous, potassium, or trace minerals; and
said disposing of said free carbon comprises at least one of spreading said impregnated activated carbon on arable land or tilling said impregnated activated carbon into arable land.

11. The process of claim 1 wherein said devolatizing produces activated carbon;
and said disposing of said free carbon comprises at least one of spreading said activated carbon on land or tilling said activated carbon into land to improve at least one of the water retention properties of said land or the texture of said land.

12. The process of claim 1 wherein said devolatizing produces activated carbon;
and further comprising using said activated charcoal to remove at least some siloxanes from landfill gas; and
said disposing of said free carbon comprises placing said used activated charcoal in one of said landfill or another landfill.

13. The process of claim 1 wherein said free carbon is activated carbon;
and further comprising using said activated charcoal to remove at least some organic components or heavy metals from a landfill leachate stream; and
said disposing of said free carbon comprises placing said activated charcoal in one of said landfill or another landfill.

14. The process of claim 1 and further comprising pelletizing said carbon-containing feedstock before said devolatizing;
and wherein said devolatizing produces activated carbon pellets;
and further comprising using said activated charcoal pellets to remove at least some organic fractions or heavy metals from a wet scrubbing system; and
said disposing of said free carbon comprises placing said activated charcoal in a landfill.

15. The process of claim 1 wherein said free carbon is activated carbon;
and further comprising using said activated charcoal to remove at least some of the mercury or heavy metals from the flue gas of a coal-fired power plant; and
said disposing of said free carbon comprises placing said activated charcoal in a landfill.

16. The process of claim 15 wherein, prior to said using said activated charcoal, further comprising impregnating said activated charcoal with a chemical to enhance mercury-capturing characteristics of said activated charcoal.

17. The process of claim 15 wherein said activated carbon is in the form of pellets; and
wherein said pellets are packed in a bed to remove said mercury or other heavy metal.

18. The process of claim 1 and further comprising:
processing said free carbon to produce finely divided carbon particles;
injecting the finely divided carbon particles into the flue of a coal-fired power plant to remove at least some of the mercury or heavy metals from the flue gas of said power plant; and
said disposing of said free carbon comprises placing said activated charcoal in a landfill.

19. A process to beneficially dispose of a carbon-containing feedstock, comprising:
pelletizing said carbon-containing feedstock;
devolatizing said pelletized feedstock to produce free carbon pellets;
co-firing said free carbon pellets along with coal in a coal-burning power plant.
